(19) United States
(12) Patent Application Publication
(10) Pub. No.: US 2026/0192452 A1
(43) Pub. Date: Jul. 9, 2026

(54) ELECTRONIC DEVICE AND METHOD WITH MOTION CONTROL

(71) Applicant: Samsung Electronics Co., Ltd., Suwon-si (KR)

(72) Inventors: Taeoh HA, Suwon-si (KR); Hyunsoo CHA, Suwon-si (KR)

(73) Assignee: Samsung Electronics Co., Ltd., Suwon-si (KR)

(21) Appl. No.: 19/232,788

(22) Filed: Jun. 9, 2025

(30) Foreign Application Priority Data
Jan. 9, 2025 (KR) 10-2025-0003495

(51) Int. Cl. B25J 9/16

(52) U.S. Cl. CPC B25J 9/1666

(57) ABSTRACT

A method and device with motion control are provided. The method includes determining reachability constraint information of the electronic device based on current pose information of the electronic device, determining collision avoidance constraint information of the electronic device based on the current pose information and sensor data of the electronic device, determining feasibility constraint information of the electronic device based on the reachability constraint information and the collision avoidance constraint information, and infer next pose information of the electronic device by inputting the feasibility constraint information and the sensor data into an artificial neural network model.

### CROSS-REFERENCE TO RELATED APPLICATIONS

This application claims the benefit under 35 USC § 119(a) of Korean Patent Application No. 10-2025-0003495, filed on Jan. 9, 2025, in the Korean Intellectual Property Office, the entire disclosure of which is incorporated herein by reference for all purposes.

### BACKGROUND

### 1. Field

The following description relates to an electronic device and method with motion control.

### 2. Description of Related Art

Robot technologies have become an important tool in modern industry and may be used in various fields, including manufacturing, logistics, healthcare, and service industries. Among these technologies, end-effectors (or working devices) such as robotic arms may play a critical role in enhancing productivity through precise motion control and high repeatability. These robotic arms may perform tasks such as object manipulation, assembly operations, and precision tasks at specific locations, and may also assist with tasks typically performed by humans.

A typical robotic arm may comprise multiple joints and an end-effector, enabling it to achieve various orientations and poses. The movements of such robotic arms are planned based on a given task goal, often utilizing complex control algorithms to achieve desired positions and poses. These control algorithms are designed to coordinate the operation of each joint to ensure synchronized and accurate task execution.

Such development in robotic arm technology extend beyond mere automating repetitive tasks, increasingly supporting decision-making and task performance in more complex environments. This further highlights the importance of robotics technology in modern industrial applications.

The above information may be presented as a related art to help with the understanding of the disclosure. No arguments or decisions are made as to whether any of the above is applicable as a prior art related to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes determining reachability constraint information of an electronic device based on current pose information of the electronic device; determining collision avoidance constraint information of the electronic device based on the current pose information and sensor data of the electronic device; determining feasibility constraint information of the electronic device based on the reachability constraint information and the collision avoidance constraint information; and inferring next pose information of the electronic device by inputting the feasibility constraint information and the sensor data into an artificial neural network model.

The determining of the reachability constraint information may include determining a movement range of a plurality of joints of the electronic device.

The determining of the reachability constraint information may include determining the reachability constraint information of the electronic device corresponding to the current pose information based on a polytopic approximation method.

The determining of the collision avoidance constraint information may include determining a joint-motion range in which a plurality of joints of the electronic device does not collide with an obstacle.

The determining of the collision avoidance constraint information may include determining safe regions for a plurality of links of the electronic device; determining an intersection of safe regions for two consecutive links among the plurality of links; and determining the collision avoidance constraint information for a common joint of the two consecutive links based on the intersection.

The determining of the safe regions may include, for each link: generating an initial ellipsoid having two joints of a corresponding link as foci; expanding the initial ellipsoid to generate a maximum-sized ellipsoid that prevents the corresponding link from colliding with an obstacle; and inscribing a polyhedron within the maximum-sized ellipsoid.

The determining of the intersection may include intersecting the polyhedron corresponding to the two consecutive links; and determining a result of the intersecting as the collision avoidance constraint information for the common joint.

The determining of the feasibility constraint information may include intersecting the reachability constraint information with the collision avoidance constraint information; and determining the feasibility constraint information based on a result of the intersecting.

The inferring of the next pose information may include determining next position information for a plurality of joints of the electronic device.

The method may further include generating a control command based on the next position information; and controlling the electronic device according to the generated control command.

In one general aspect, provided is a non-transitory computer-readable storage medium storing instructions that, in response to being executed by one or more processors, cause the one or more processors to perform the method described herein.

In one general aspect, an electronic device includes one or more processors configured to: determine reachability constraint information of an electronic device based on current pose information of the electronic device; determine collision avoidance constraint information of the electronic device based on the current pose information and sensor data of the electronic device; determine feasibility constraint information of the electronic device based on the reachability constraint information and the collision avoidance constraint information; and infer next pose information of the electronic device by inputting the feasibility constraint information and the sensor data into an artificial neural network model.

The one or more processors may be further configured to: determine a movement range of a plurality of joints of the electronic device.

The one or more processors may be further configured to: determine the reachability constraint information of the electronic device corresponding to the current pose information based on a polytopic approximation method.

The one or more processors may be further configured to determine a joint-motion range in which a plurality of joints of the electronic device does not collide with an obstacle.

The one or more processors may be further configured to determine safe regions for a plurality of links of the electronic device; determine an intersection of safe regions for two consecutive links among the plurality of links; and determine the collision avoidance constraint information for a common joint of the two consecutive links based on the intersection.

The one or more processors may be further configured to, for each link: generate an initial ellipsoid having two joints constituting a corresponding link as foci; expand the initial ellipsoid to generate a maximum-sized ellipsoid that prevent the corresponding link from colliding with an obstacle; and inscribe a polyhedron within the maximum-sized ellipsoid.

The one or more processors may be further configured to intersect the polyhedron corresponding to the two consecutive links; and determine the intersection of the polyhedron as the collision avoidance constraint information for the common joint.

The one or more processors may be further configured to intersect the reachability constraint information and the collision avoidance constraint information to determine the feasibility constraint information.

The one or more processors may be further configured to determine next position information of a plurality of joints of the electronic device; generate a control command based on the next position information; and actuate the electronic device according to the control command.

Other features and aspects will be apparent from the following detailed description, the drawings, and the claims.

### BRIEF DESCRIPTION OF THE DRAWINGS

FIG. 1A illustrates an example electronic device according to one or more embodiments.

FIG. 1B illustrates an example inverse kinematics according to one or more embodiments.

FIG. 2 illustrates an example feasibility constraint of an electronic device according to one or more embodiments.

FIGS. 3A and 3B illustrate respective example collision avoidance constraint of a robotic arm according to one or more embodiments.

FIG. 4 illustrates an example feasibility constraint for each joint of a robotic arm according to one or more embodiments.

FIG. 5A illustrates an example method of inferring next pose information of a robot using an artificial neural network model according to one or more embodiments.

FIG. 5B illustrates an example method of training an artificial neural network model according to one or more embodiments.

FIG. 6 illustrates an example control method of an electronic device according to one or more embodiments.

FIG. 7 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

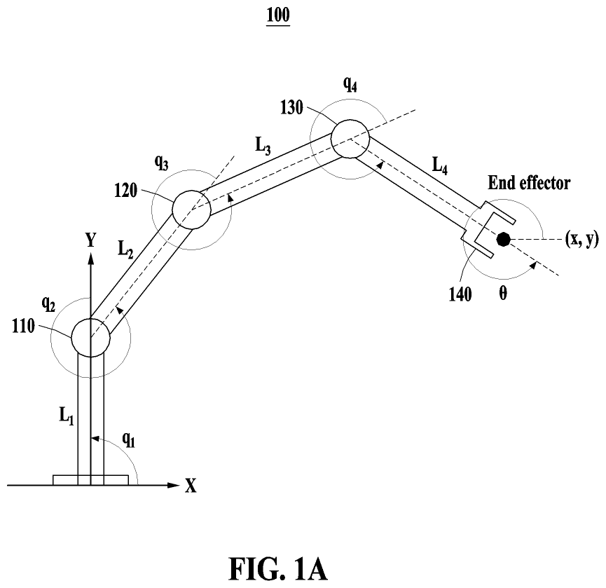

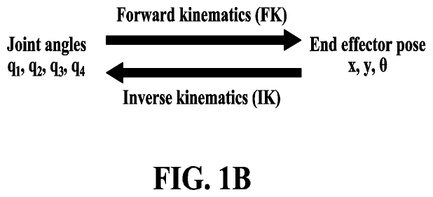

FIG. 1A illustrates an example electronic device according to one or more embodiments.

Referring to FIG. 1A, a robotic arm 100 is illustrated as a representative example of an electronic device. However, the electronic device is not limited to the robotic arm 100, and may be implemented in various forms, including industrial automation equipment, medical robots, and logistics robots, as non-limiting examples.

The robotic arm 100 may include a plurality of joints 110, 120, and 130 and an end-effector 140. The end-effector 140 is positioned at a distal end of the robotic arm 100 and may include a work tool or sensor configured to interact with a work target or perform a designated task. For example, the end-effector 140 may include a gripper, an adsorber, a welder, and/or a sensor such as a camera.

The end-effector 140 may occupy different positions at time points of t=0, t=1, and t=2. Such positional changes may result from the prediction of a next pose of the end-effector 140 using an artificial neural network model. The artificial neural network model may be trained to receive sensor data and output a prediction of the next/subsequent pose of the end-effector 140. The predicted next pose may be used to determine in which direction and at what angle each of the joints 110, 120, and 130 of the robotic arm 100 should move. At this stage, the movements of the joints may be determined using inverse kinematics based on an optimization theory.

FIG. 1B illustrates an example inverse kinematics according to one or more embodiments. The description provided with reference to FIG. 1A may also apply to FIG. 1B.

Referring to FIG. 1B, the angles of the joints 110, 120, and 130 of the robotic arm 100 may determine the pose of the end-effector 140 through forward kinematics (FK). Conversely, a target pose of the end-effector 140 may be achieved in the reverse direction using inverse kinematics to determine the angles of the joints 110, 120, and 130. In other words, the inverse kinematics may refer to the process of determining the respective positions that the joints 110, 120, and 130 should take to reach a target pose of the end-effector 140 of the robotic arm when the target pose is given.

The pose information of the robotic arm 100 may include pose information and/or position information of each component of the robotic arm 100. For example, the pose information of the robotic arm 100 may include the pose information of the end-effector 140 and the position information of the joints 110, 120, and 130.

The position information of the end-effector 140 may indicate the position and orientation of the end-effector in the workspace. For example, the position may be expressed as (x, y, z) coordinates in a three-dimensional coordinate system, and the orientation may be expressed as roll, pitch, and yaw angles (φ, θ, ψ) indicating a rotational state of the end-effector 140. The pose information may accurately define where the end-effector 140 is and in what orientation the end-effector 140 is facing, thereby performing a specific task within the workspace of the robotic arm 100.

For example, the end-effector 140 may be positioned at coordinates (x, y, z)=(300 mm, 200 mm, 150 mm) with an orientation of φ=0°, θ=90°, ψ=0°. In such a case, the pose information of the end-effector 140 may be expressed as (300 mm, 200 mm, 150 mm, 0°, 90°, 0°). However, the method of expressing the pose information of the end-effector 140 is not limited to the examples described above.

The position information of the joints 110, 120, and 130 may include values representing the rotation angle and/or displacement of each of the joints 110, 120, and 130 of the robotic arm 100. Each joint may have its own rotation axis or translation axis, and position information of each joint may be expressed as a rotation angle θ; and/or displacement di about that axis, where i represents the joint number.

For example, the robotic arm 100 may include three rotational joints 110, 120, and 130, and the first joint 110 may have a rotation angle θ₁=30°, the second joint 120 may have a rotation angle θ₂=45°, and the third joint 130 may have a rotation angle θ₂=60°. These joint angles represent the joint position information necessary to realize the pose information of the end-effector 140 and may be derived using inverse kinematics. That is, when target pose information of the end-effector 140 is given, it is determined by what angle each of the joints 110, 120, and 130 should rotate to achieve the target pose information. However, the method of expressing the position information of the joints 110, 120, and 130 is not limited to the examples described above.

For example, when the artificial neural network model predicts that the next pose of the end-effector 140 should be at coordinates (400 mm, 100 mm, 200 mm) with an orientation of φ=0°, θ=45°, ψ=90°, the inverse kinematics may determine that the rotation angle θ₁ of the first joint 110 is 20°, the rotation angle θ₂ of the second joint 120 is 35°, and the rotation angle θ₃ of the third joint 130 is 55°.

A determined joint movement is transferred to each joint via a controller, allowing the joints to move into the desired configuration (e.g., expected pose). By repeatedly performing this process, the robotic arm 100 may complete a series of task instructions. For example, the task instructions may include assembling a specific work piece, moving an object, and/or performing a precision task. The controller may be integrated into the robotic arm 100 or may be implemented as a separate device.

As described above, the artificial neural network model may be trained to predict the next pose of the end-effector 140 based on sensor input. However, typical training methods have the problem of not considering feasibility during the training process. In this context, feasibility may refer to a criterion for evaluating whether the electronic device (e.g., the robotic arm 100) may perform safe and physically feasible operations within the workspace. When the feasibility is not taken into account during the training process, the artificial neural network model may generate a next pose that the electronic device is actually unable to take. When the next pose is generated that is actually unable to take, the position information of the electronic device may not be determined properly, potentially causing malfunction, erratic behavior, and/or failure to complete the intended task.

As will be described in detail below, according to one or more embodiments, the prediction of the next pose incorporates feasibility considerations to ensure that the electronic device (e.g., the robotic arm 100) operates safely and within a valid range of motion. This allows for more accurate and reliable control of the robotic arm.

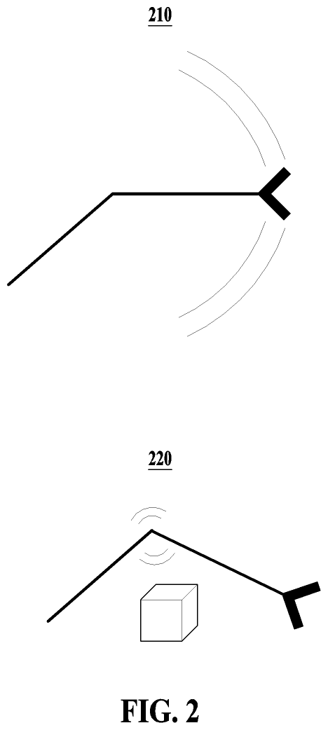

FIG. 2 illustrates an example feasibility constraint information of an electronic device according to one or more embodiments. The description provided with reference to FIGS. 1A and 1B may also apply to FIG. 2.

Referring to FIG. 2, the electronic device may operate within a defined workspace and may plan and perform the task based on a reachability constraint and a collision avoidance constraint. For convenience of description, the electronic device will hereinafter be described as a robotic arm (e.g., the robotic arm 100 described above with reference to FIG. 1A), but the electronic device is not limited thereto.

As shown in diagram 210, the reachability constraint may define a maximum range that the robotic arm may reach in the absence of obstacles. The reachability constraint may be determined based on physical characteristics of joints and links of the robotic arm, such as rotation ranges of the joints and lengths of the links. For example, when each link of the robotic arm has a length of 1 meter and each joint has a rotation range between 0 and 180 degrees, the robotic arm may reach a hemispherical workspace with a radius of up to 2 meters.

Using the dynamic equations of the robotic arm and the polytopic approximation method, the reachable workspace of the robotic arm may be approximately expressed.

$$M ( q ) \ddot{q} + C ( q , \dot{q} ) \dot{q} + {𝒯}_{g} ( q ) = 𝒯 \qquad Equation 1$$

Equation 1, for example, is the dynamic equation that governs the movement of the robotic arm. q is a joint position (angle) vector of the robotic arm, \dot{q} is a joint velocity vector of the robotic arm, \ddot{q} is a joint acceleration vector of the robotic arm, M(q) is a mass matrix of the robotic arm, representing the inertial effect according to the movement of the joint, C(q, \dot{q})\dot{q} represents the Coriolis force and centrifugal force according to the velocity of the joint, τ_{g}(q) represents a gravitational torque according to the joint position of the robotic arm, and τ represents an input torque acting on the robotic arm. Equation 1 may be used to mathematically model a relationship between the joint position and velocity of the robotic arm and the input torque, and to describe the dynamic constraint required when the robotic arm performs a specific movement.

The reachability constraint of the robotic arm may use the polytopic approximation method such as Equation 2 to mathematically approximate a region reachable by the robotic arm within the workspace during a specific time (e.g., tₕ).

$$\begin{matrix}{𝒫}_{x} = \{ {x}_{k + 1} ∈ {R}^{m} \vert {x}_{k + 1} = {J}_{k} {M}_{k}^{- 1} \frac{{t}_{2}^{2}}{2} 𝒯 + {x}_{k + 1}^{*} , \\ 𝒯 ∈ [ {𝒯}_{min} , {𝒯}_{max} ] , \\ {M}_{k}^{- 1} {t}_{h} ( 𝒯 - {𝒯}_{d} ) + {\dot{q}}_{k} ∈ [ {\dot{q}}_{min} , {\dot{q}}_{max} ] , \\ {M}_{k}^{- 1} \frac{{t}_{h}^{2}}{2} ( 𝒯 - {𝒯}_{d} ) + {\dot{q}}_{k} {t}_{h} + {q}_{k} ∈ [ {q}_{min} , {q}_{max} ] \}\end{matrix} \qquad [ Equation 2 ]$$

xₖ₊₁ is a vector representing the position within the workspace reachable by the robotic arm at time k+1, and R^{m} is a dimension of the workspace of the robotic arm, which may be, for example, m=2 for a two-dimensional workspace, and m=3 for a three-dimensional workspace. Jₖ is the Jacobian matrix of the robotic arm at time k, representing a transformation relationship between a joint space and the workspace,

$${M}_{k}^{- 1}$$

represents an inverse matrix of the mass matrix M(q) at the time k, th represents a prediction time horizon, and τ is an input torque and may have a value between τₘᵢₙ and τₘₐₓ. τ_{d} represents a gravitational torque, \dot{q}ₖ represents a joint velocity at the time k, and qₖ represents a joint position at the time k.

Referring to Equations 1 and 2, the position xₖ₊₁ reachable by the robotic arm within the workspace during the time tₕ may be determined based on current states of the Jacobian matrix Jₖ, the mass matrix Mₖ, the input torque τ, and the joint velocity and position. At this stage, the input torque may be considered within the range [τₘᵢₙ, τₘₐₓ]. The velocity and position of the joint may be within the ranges of [\dot{q}ₘᵢₙ, \dot{q}ₘₐₓ], [qₘᵢₙ, qₘₐₓ]. These constraints may ensure that the movements of the robotic arm are performed within a physically feasible range. The reachable area of the robotic arm within the workspace may be approximated by a polytopic inequality constraint. This may be expressed in the form Ax≤b, which may be defined to restrict the movement of the robotic arm in the workspace to within a specific polytope.

The reachability constraint, determined using the polytopic approximation method, may be used to define the workspace in which the robotic arm may operate safely and efficiently. For example, the reachable range within a specific workspace may be clearly defined while the robotic arm is performing an assembly task. However, the method of determining the reachability constraint is not limited to the example described above. Alternative approximation methods may also be employed to determine the reachability constraint.

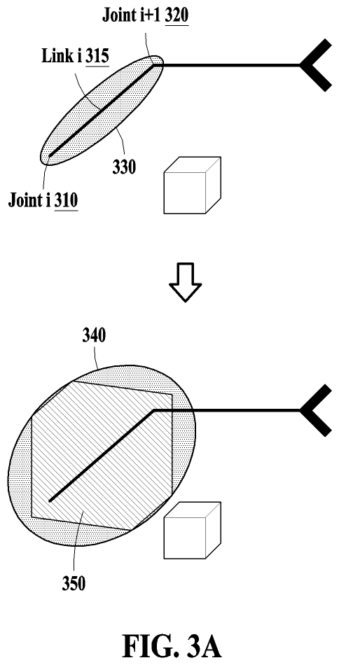

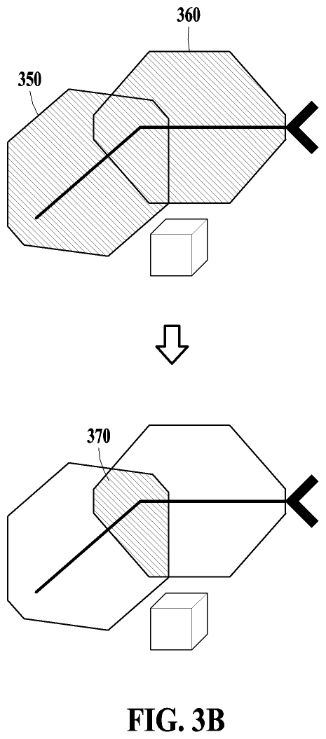

Referring to diagram 220, the collision avoidance constraint may define the range within which the robotic arm may operate without colliding with obstacles within the work environment. The collision avoidance constraint may be dynamically determined by considering the positions and dimensions of obstacles along the robotic arm's operation path and within the working environment of the robotic arm. For example, when an obstacle with a size of 0.5 meters is present in the workspace, the robotic arm may operate while maintaining a safe distance (i.e., a safety region) from the obstacle. This safe region may be determined by restricting a rotation angle and/or position of a specific joint of the robotic arm to prevent the specific joint from colliding with obstacles. A method of determining the collision avoidance constraint will be described in detail below with reference to FIGS. 3A and 3B.

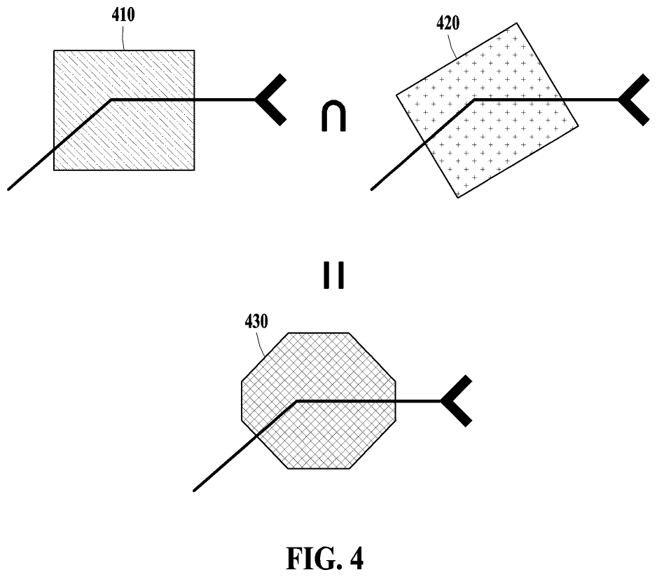

The feasibility constraint may be defined as an intersection of the reachability constraint and the collision avoidance constraint. The reachability constraint may represent the range that the robotic arm may physically reach, and the collision avoidance constraint may define the range within which the robotic arm may operate without encountering obstacles. The overlapping region between the two constraints represents the safe and feasible operating range for the robotic arm. For example, when the robotic arm has a range with a radius of 2 meters and an obstacle is located within this workspace, the feasible operating range may be reduced accordingly to avoid the collision with the obstacle. The feasibility constraint may serve as a critical input in the training process of the robotic arm and may contribute to ensuring the robotic arm to operate safely and efficiently. A method of determining the feasibility constraint based on the reachability constraint and the collision avoidance constraint will be described in detail below with reference to FIG. 4.

FIGS. 3A and 3B illustrate example collision avoidance constraint of a robotic arm according to one or more embodiments. The description provided with reference to FIGS. 1A through 2 may also apply to FIGS. 3A and 3B.

Referring to FIG. 3A, a link refers to a structural component that connects joints and facilitates the movement of the robotic arm. For example, a link i 315 may connect a joint i 310 and a joint i+1 320, where the joint i 310 may represent a starting point of the link and the joint i+1 320 may represent an end point of the link (where i is a natural number).

An initial ellipsoid 330 may be defined based on the link i 315, with the joint i 310 and the joint i+1 320 serving as its foci. The initial ellipsoid 330 may represent an approximate safe region within which the link i 315 may move within the workspace.

The initial ellipsoid may be determined based on a length of the link and a range of movement/motion within the workspace. For example, assuming that the link i has a length of 1 meter and the link may swing within a range of 0.5 meters within the workspace, the initial ellipsoid 330 may be designed to encompass the entire range of movement/motion of the link.

The initial ellipsoid 330 may be expanded to define a maximum-sized safe region by taking into account the collision with obstacles in the workspace. This expansion may be performed using an optimization algorithm (e.g., the Iterative Regional Inflation by Semidefinite (IRIS) algorithm). During this process, the algorithm may optimize the distance to the obstacles and the size of the ellipsoid, ensuing that the link may secure the maximum range of movement without colliding with obstacles (e.g., a safe operational margin). For example, assuming that an obstacle is located at a distance of 0.3 meters from the link, the IRIS algorithm may shrink or reshape the ellipsoid to preserve the required safety distance.

An expanded ellipsoid 340 may be converted into a polyhedron 350 to more precisely define the range of the link's allowable movement/motion within the workspace. The polyhedron 350, which approximates the shape of the expanded ellipsoid 340, may represent a bounded safe operation region/range for the robotic arm within the workspace. For example, the polyhedron 350, inscribed within the expanded ellipsoid 340, may define a constraint region within which the link i may move without colliding with an obstacle. The polyhedron 350 may specifically restrict the movement of the link within the workspace and may mathematically express the collision avoidance constraint.

Referring to FIG. 3B, the polytopic constraint associated with each link may be used to determine a collision avoidance constraint region of a joint through the intersection operation.

A collision avoidance constraint region 370 corresponding to the joint i+1 320 may be the intersection region of the polyhedron 350 corresponding to the link i 315 and a polyhedron 360 corresponding to the link i+1. The collision avoidance constraint region 370 may refer to the range in which the joint i+1 320 may safely operate without colliding with obstacles during execution of a task. The intersection is determined to represent the overlapping region of two polyhedrons, and this region corresponds to a feasible, collision-free movement space for the joint within the workspace. By applying this intersection process across all links, the collision avoidance constraint region corresponding to each joint may be systematically determined.

For example, assuming that the polyhedron 350 corresponding to the link i 315 occupies a range of [−0.5, 0.5] meters along the x-axis and occupies a range of [0, 0.8] meters along the y-axis, and the polyhedron 360 corresponding to the link i+1 occupies a range of [−0.3, 0.7] meters along the x-axis and occupies a range of [0.1, 0.9] meters along the y-axis, the intersection region 370 of the two polyhedrons may span [−0.3, 0.5] meters along the x-axis and [0.1, 0.8] meters along the y-axis.

FIG. 4 illustrates an example feasibility constraint for each joint of a robotic arm according to one or more embodiments. The description provided with reference to FIGS. 1A through 3B may also apply to FIG. 4.

Referring to FIG. 4, a reachability constraint region 410 may define a maximum range within which a corresponding joint may move within the workspace of the robotic arm without obstacles. A collision avoidance constraint region 420 may define a range within which a joint may move while avoiding the collision with obstacles by considering the obstacles in the workspace. A feasibility constraint region 430 may be derived as the intersection of the reachability constraint region 410 and the collision avoidance constraint region 420. The feasibility constraint region 430 may represent a final range within which the joint may move safely while satisfying both physical and environmental conditions/constraints.

The feasibility constraint region 430 may be defined through the intersection operation, which may be mathematically expressed in the form of the polytopic inequality. For example, the feasibility constraint region 430 may be expressed in the form of Ax≤b, where x is a vector representing position information of the joint, and may include joint-related variables such as the position, velocity, acceleration. Matrices A and b, combined with a vector x representing the position information of the joint, define the polytopic constraint condition, which may represent the allowable/feasible range of movement of the joint within the workspace. In actual applications, the values of A and b may be set based on the physical limitations of the robotic arm and environmental conditions, such as obstacle locations or workspace dimensions.

The finally determined feasibility constraint may be used to plan the movement of each joint of the robotic arm. In particular, the constraint is suitable to serve as input to an artificial neural network model. For example, when the robotic arm predicts a next movement to perform a specific task, the feasibility constraint region 430 for each joint may be provided for each joint as the input to the neural network to generate a movement (e.g., a motion plan) that satisfies the physical and environmental conditions. Based on this input, the neural network may output the next position or velocity of the joint to perform a task.

In industrial robots, the intersection of the reachability and collision avoidance constraints may define safe operating conditions for task execution within a factory, avoiding collisions with machinery. In surgical robots, the feasibility constraint for each joint may be determined based on the collision avoidance constraint considering patients and medical instruments, enabling safe and precise procedures. Similarly, in logistics robots, the intersection of the reachability constraint and the collision avoidance constraint may be determined to plan the safe operation range of each joint when moving or organizing boxes in a warehouse environment.

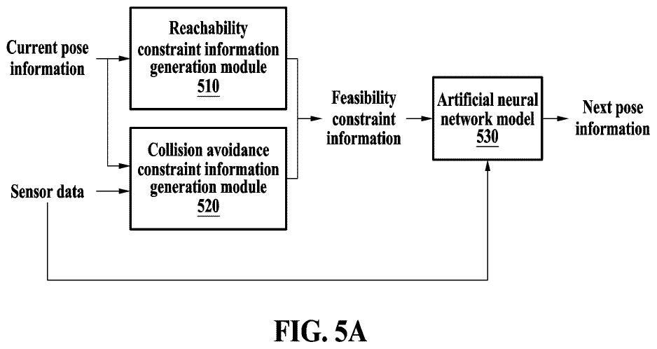

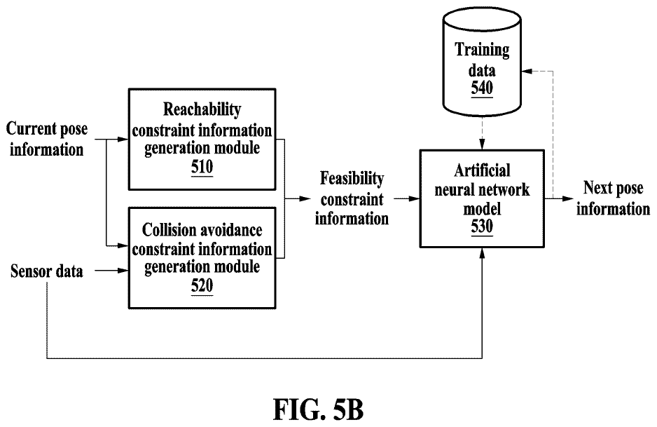

FIG. 5A illustrates an example method of inferring next pose information of a robot using an artificial neural network model according to one or more embodiments. The description provided with reference to FIGS. 1A through 4 may also apply to FIG. 5A.

Referring to FIG. 5A, a reachability constraint information generation module 510 and a collision avoidance constraint information generation module 520 may each generate respective information based on current pose information and sensor data. The term “module” refers to a unit including one or a combination of two or more of hardware, software, or firmware. The “module” may be used interchangeably with other terms, for example, “unit,” “logic,” “logical block,” “component,” or “circuit.” The “module” may be a minimum unit of an integrally formed component or part thereof. The “module” may be a minimum unit for performing one or more functions or part thereof. The “module” may be implemented mechanically or electronically. For example, the “module” may include at least one of an application-specific integrated circuit (ASIC) chip, a field-programmable gate arrays (FPGAs), or a programmable-logic device for performing certain operations that are well known or to be developed in the future.

The current pose information may include position information of a plurality of joints, and the sensor data may include image data obtained through a camera. However, the sensor data is not limited thereto and may include a variety of sensor information such as light detection and ranging (LiDAR) data and/or radio detection and ranging (radar) data.

The reachability constraint information generation module 510 may receive the current pose information, and generate reachability constraint information that defines a range within which the joints of the robotic arm may physically move. The collision avoidance constraint information generation module 520 may receive the current pose information and the sensor data, and generate collision avoidance constraint information that takes obstacles into account. The sensor data input to the collision avoidance constraint information generation module 520 may include information related to obstacles within the workspace.

The generated reachability and collision avoidance constraint information may be combined to derive feasibility constraint information. As illustrated in FIG. 4, the feasibility constraint information may include a polytopic inequality in the form of Ax≤b, and the values of A and b, together with sensor data, may be provided as inputs to an artificial neural network model 530.

The artificial neural network model 530 may receive the sensor data as an additional input to infer the next pose information of the robotic arm. The sensor data input to the artificial neural network model 530 may include visual observation information representing a current state of the robotic arm. An output of the artificial neural network model 530 may be the next pose information. The next pose information output through the artificial neural network model 530 may be converted into next position information (e.g., joint positions) of the plurality of joints using inverse kinematics.

In addition, the reachability and collision avoidance constraint information generation modules 510 and 520 may be implemented as an artificial neural network model as well as a module based on an existing geometric algorithm. For example, the reachability constraint information generation module 510 may be implemented as an artificial neural network model that receives the current pose information to be trained to learn a nonlinear relationship between joints to estimate feasible movement ranges of the joints. The collision avoidance constraint information generation module 520 may also be implemented as a neural network-based module that is trained on the sensor data as an input to determine a safe operational range for the robotic arm considering the locations and dimensions of obstacles within the workspace.

Further, the reachability and collision avoidance constraint information generation modules 510 and 520 may be trained together with the artificial neural network model 530 in an end-to-end manner. In such a configuration, a single neural network model may directly receive the sensor data and the current pose information as inputs and immediately outputs the next pose information, without separately generating the reachability constraint information and the collision avoidance constraint information. The end-to-end training may allow a model to generate optimal next pose information while simultaneously considering the task environment and constraints.

FIG. 5B illustrates an example method of training an artificial neural network model according to one or more embodiments. The description provided with reference to FIGS. 1A through 5A may also apply to FIG. 5B.

Referring to FIG. 5B, the artificial neural network model 530 may be trained for various movements and task conditions of the robotic arm based on training data 540. The training data 540 may include the current pose information of the plurality of joints and the corresponding sensor data. For example, the training data 540 may include pose information used in the past for the robotic arm to perform a specific task. The training data 540 may form input-output pairs required to train the artificial neural network model 530.

Input data may be provided to the artificial neural network model 530 through the training data 540, and the artificial neural network model 530 may infer the next pose information based on the input data. The next pose information output by the artificial neural network model 530 may be compared with desired pose information to generate an error. The error may be defined mathematically through a loss function. For example, the error may be determined using the Euclidean distance between the predicted pose information and the actual pose information or other measurement references.

The error may be used to adjust/update training parameters (weights and biases) of the neural network. This process may be performed using the backpropagation algorithm and optimization techniques (e.g., stochastic gradient descent). The backpropagation algorithm updates the weights and biases of each layer to reduce the error, and as this process is repeated, the model may be trained to generate increasingly accurate outputs, thereby improving its prediction accuracy over time.

The artificial neural network model 530 may be trained to perform a predetermined single task or multiple tasks. In the case of multiple tasks, task instruction information may be included as a part of the input data. The task instruction information is data indicating a feature related to a specific task and helps the model distinguish between different tasks. For example, when the specific task is to move an object and another task is an assembly task, the task instruction information may help the model infer the next pose information appropriate for each task, enabling task-specific pose prediction.

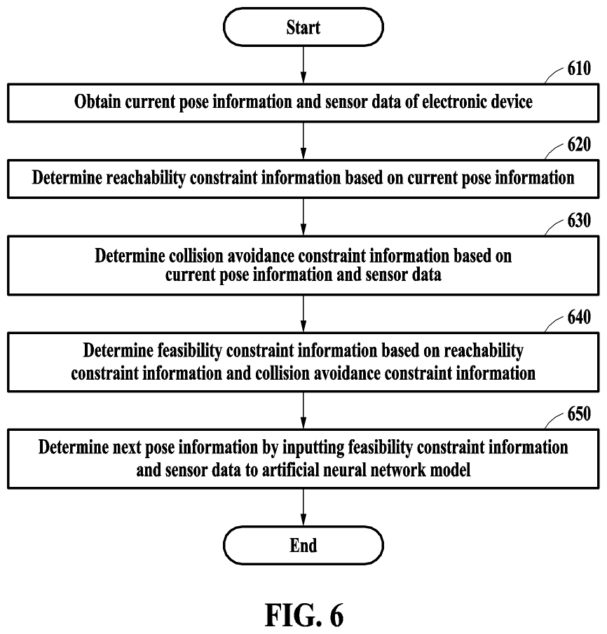

FIG. 6 illustrates an example control method of an electronic device according to one or more embodiments. The description provided with reference to FIGS. 1A through 5B may also apply to FIG. 6.

For convenience of description, operations 610 through 650 are described as being performed using the electronic device described above with reference to FIGS. 1A through 5. However, these operations may also be performed by any suitable electronic device or system.

While FIG. 6 illustrates the operations in a particular order, the sequence may be altered or some steps omitted, without departing from the spirit and scope of the shown example. The operations shown in FIG. 6 may also be performed in parallel or concurrently.

In operation 610, the electronic device may obtain current pose information and sensor data. The current pose information may include position and velocity information of a plurality of joints, and the sensor data may include data obtained via various sensors such as camera, LiDAR, radar, and other sensor systems. For example, image data obtained through the camera sensor may provide visual context for analyzing the workspace of the robotic arm.

In operation 620, the electronic device may determine/generate reachability constraint information based on the current pose information. This operation may include determining/generating information on the range of movement of a plurality of joints of the robotic arm using a polytopic approximation method.

In operation 630, the electronic device may determine/generate collision avoidance constraint information based on the current pose information and the sensor data. This operation may include identifying a range in which the plurality of joints of the electronic device does not collide with an obstacle, determining safe regions for a plurality of links, and determining an intersection of safe regions for adjacent links (e.g., two consecutive links) among the plurality of links, and determining a common joint of the two consecutive links based on a region corresponding to the intersection. The electronic device may, for each link, generate an initial ellipsoid having two joints constituting the corresponding link as foci, determine a maximum-sized ellipsoid within a range in which the corresponding link does not collide with an obstacle based on the initial ellipsoid, and determine a polyhedron inscribed in the maximum-sized ellipsoid. The electronic device may determine an intersection of the polyhedron corresponding to the two consecutive links, and determine the intersection of the polyhedron as the collision avoidance constraint information of the common joint.

In operation 640, the electronic device may determine/generate feasibility constraint information based on the reachability constraint information and the collision avoidance constraint information. This operation may include determining an intersection of the reachability constraint information and the collision avoidance constraint information, and determining/generating the feasibility constraint information based on the intersection.

In operation 650, the electronic device may input the feasibility constraint information and the sensor data into an artificial neural network model to infer/generate next pose information of the electronic device.

The electronic device may convert the next pose information into next position information of the plurality of joints using the inverse kinematics. The electronic device may generate a control command based on the next position information, enabling the electronic device to perform the desired movement according to the control command.

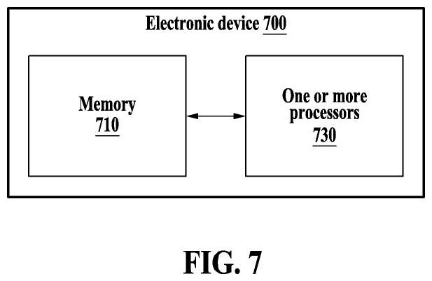

FIG. 7 illustrates an example electronic device according to one or more embodiments. The description provided with reference to FIGS. 1A through 6 may also apply to FIG. 7.

Referring to FIG. 7, an electronic device 700 may include a memory 710 and a processor 730. The electronic device 700 is a device that includes a robotic arm to resolve deadlocks and continue tasks in various task environments, such as a walking assist device (WAD), a drone, an autonomous vehicle, a surgical robot, a warehouse automation robot, construction equipment, a space exploration robot, a household robot, an agricultural robot, or an environmental purification robot, and may include components for predicting an optimal recovery pose based on a task instruction and executing the same.

The memory 710 may store instructions (or programs) executable by the processor 730. For example, the instructions may include instructions to perform an operation of the processor 730 and/or an operation of each component of the processor 730.

The memory 710 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 730 may process data stored in the memory 710. The processor 730 may execute computer-readable code (e.g., software) stored in the memory 710 and instructions triggered by the processor 730.

The processor 730 may be a hardware-implemented data processing device having a circuit that is physically structured to execute desired operations. The desired operations may include, for example, code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 730 may control to obtain current pose information and sensor data of the electronic device, determine reachability constraint information of the electronic device based on the current pose information, determine collision avoidance constraint information of the electronic device based on the current pose information and the sensor data, determine feasibility constraint information of the electronic device based on the reachability constraint information and the collision avoidance constraint information, and determine next pose information of the electronic device by inputting the feasibility constraint information and the sensor data to an artificial neural network model. The processor 730 may perform the operations described with reference to FIGS. 1A to 6 in substantially the same manner. Accordingly, further description thereof is omitted herein.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

While the examples are described with reference to drawings, it will be apparent to one of ordinary skill in the art that various alterations and modifications in form and details may be made in these examples without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other examples, and equivalents to the claims are also within the scope of the following claims.

What is claimed is:

1. A processor-implemented method, the method comprising:
determining reachability constraint information of an electronic device based on current pose information of the electronic device;
determining collision avoidance constraint information of the electronic device based on the current pose information and sensor data of the electronic device;
determining feasibility constraint information of the electronic device based on the reachability constraint information and the collision avoidance constraint information; and
inferring next pose information of the electronic device by inputting the feasibility constraint information and the sensor data into an artificial neural network model.

2. The method of claim 1, wherein the determining of the reachability constraint information comprises determining a movement range of a plurality of joints of the electronic device.

3. The method of claim 1, wherein the determining of the reachability constraint information comprises determining the reachability constraint information of the electronic device corresponding to the current pose information based on a polytopic approximation method.

4. The method of claim 1, wherein the determining of the collision avoidance constraint information comprises determining a joint-motion range in which a plurality of joints of the electronic device does not collide with an obstacle.

5. The method of claim 1, wherein the determining of the collision avoidance constraint information comprises:
determining safe regions for a plurality of links of the electronic device;
determining an intersection of safe regions for two consecutive links among the plurality of links; and
determining the collision avoidance constraint information for a common joint of the two consecutive links based on the intersection.

6. The method of claim 5, wherein the determining of the safe regions comprises, for each link:
generating an initial ellipsoid having two joints of a corresponding link as foci;
expanding the initial ellipsoid to generate a maximum-sized ellipsoid that prevents the corresponding link from colliding with an obstacle; and
inscribing a polyhedron within the maximum-sized ellipsoid.

7. The method of claim 6, wherein the determining of the intersection comprises:
intersecting the polyhedron corresponding to the two consecutive links; and
determining a result of the intersecting as the collision avoidance constraint information for the common joint.

8. The method of claim 1, wherein the determining of the feasibility constraint information comprises:
intersecting the reachability constraint information with the collision avoidance constraint information; and
determining the feasibility constraint information based on a result of the intersecting.

9. The method of claim 1, wherein the inferring of the next pose information comprises determining next position information for a plurality of joints of the electronic device.

10. The method of claim 9, further comprising:
generating a control command based on the next position information; and
controlling the electronic device according to the generated control command.

11. A non-transitory computer-readable storage medium storing instructions that, in response to being executed by one or more processors, cause the one or more processors to perform the method of claim 1.

12. An electronic device comprising:
one or more processors configured to:
determine reachability constraint information of an electronic device based on current pose information of the electronic device;
determine collision avoidance constraint information of the electronic device based on the current pose information and sensor data of the electronic device;
determine feasibility constraint information of the electronic device based on the reachability constraint information and the collision avoidance constraint information; and
infer next pose information of the electronic device by inputting the feasibility constraint information and the sensor data into an artificial neural network model.

13. The electronic device of claim 12, wherein the one or more processors are further configured to:
determine a movement range of a plurality of joints of the electronic device.

14. The electronic device of claim 12, wherein the one or more processors are further configured to:
determine the reachability constraint information of the electronic device corresponding to the current pose information based on a polytopic approximation method.

15. The electronic device of claim 12, wherein the one or more processors are further configured to:
determine a joint-motion range in which a plurality of joints of the electronic device does not collide with an obstacle.

16. The electronic device of claim 12, wherein the one or more processors are further configured to:
determine safe regions for a plurality of links of the electronic device;
determine an intersection of safe regions for two consecutive links among the plurality of links; and
determine the collision avoidance constraint information for a common joint of the two consecutive links based on the intersection.

17. The electronic device of claim 16, wherein the one or more processors are further configured to, for each link:
generate an initial ellipsoid having two joints constituting a corresponding link as foci;
expand the initial ellipsoid to generate a maximum-sized ellipsoid that prevent the corresponding link from colliding with an obstacle; and
inscribe a polyhedron within the maximum-sized ellipsoid.

18. The electronic device of claim 17, wherein the one or more processors are further configured to:
intersect the polyhedron corresponding to the two consecutive links; and
determine the intersection of the polyhedron as the collision avoidance constraint information for the common joint.

19. The electronic device of claim 12, wherein the one or more processors are further configured to:
intersect the reachability constraint information and the collision avoidance constraint information to determine the feasibility constraint information.

20. The electronic device of claim 12, wherein the one or more processors are further configured to:
determine next position information of a plurality of joints of the electronic device;
generate a control command based on the next position information; and
actuate the electronic device according to the control command.
